(19) United States
(12) Patent Application Publication
(10) Pub. No.: US 2015/0011380 A1
(43) Pub. Date: Jan. 8, 2015

(54) CATALYST FOR CARBON NANOTUBE PRODUCTION

(71) Applicant: MITSUBISHI HEAVY INDUSTRIES, LTD., Tokyo (JP)

(72) Inventors: Nariyuki Tomonaga, Tokyo (JP); Tomoaki Sugiyama, Tokyo (JP); Yasushi Mori, Tokyo (JP); Takashi Kurisaki, Tokyo (JP); Takanori Suto, Tokyo (JP); Kota Kikuchi, Tokyo (JP)

(21) Appl. No.: 14/378,678

(22) PCT Filed: Feb. 22, 2013
(86) PCT No.: PCT/JP2013/054561

§ 371 Date: Aug. 14, 2014

(30) Foreign Application Priority Data
Feb. 22, 2012 (JP) 2012-036249

(51) Int. Cl. B01J 23/78

(52) U.S. Cl. CPC B01J 23/78
USPC 502/100

(57) ABSTRACT

The present invention provides a catalyst for carbon nanotube production capable of continuously mass-producing a carbon nanotube having a long fiber length and excellent conductivity. The catalyst for carbon nanotube production of the present invention includes a carrier particle which is configured to include a metal oxide and has voids therein, and a metal catalyst which is carried on the carrier particle. In a pore distribution curve of the carrier particle which is obtained by a mercury penetration method, when an integrated value of volumes of pores having a pore size of equal to or larger than 0.1 μm is set to be a volume of voids per unit mass of the carrier particle, the volume of the voids is set to be in a range of 0.6 cm³/g to 2.2 cm³/g.

### TECHNICAL FIELD

The present invention relates to a catalyst for generating a carbon nanotube, and more particularly, to a catalyst for carbon nanotube production which is used when generating a carbon nanofiber suitable as a conductive filler in a fluidized bed.

Priority is claimed on Japanese Patent Application No. 2012-36249, filed Feb. 22, 2012, the content of which is incorporated herein by reference.

### BACKGROUND ART

A carbon nanotube is a tube-shaped carbon polyhedron having a structure in which a graphite sheet is cylindrically closed. The carbon nanotube includes a multi-walled nanotube having a multi-layer structure in which a graphite sheet is cylindrically closed and a single-walled nanotube having a single-layer structure in which a graphite sheet is cylindrically closed.

Here, the multi-walled nanotube, which is present in a carbon mass deposited on a cathode during arc discharging, was discovered by Iijima in 1991 (see NPL 1). Thereafter, studies of the multi-walled nanotube have been conducted actively. Thus, in recent years, large quantities of multi-walled nanotubes have been synthesized.

On the other hand, the single-walled nanotube generally has an inner diameter of approximately 0.4 nm to 10 nm, and the synthesis thereof was reported simultaneously by Iijima and the IBM group in 1993. An electronic state of the single-walled nanotube may be theoretically predicted, and an electronic property is considered to change from a metallic property to a semiconducting property depending on how being wound in a spiral. Accordingly, the single-walled nanotube is a promising electronic material of the future. A nanoelectronics material, an electric field electron emitter, a highly-directional radiation source, a soft X-ray source, a one-dimensional conducting material, a highly thermally conducting material, a hydrogen storage material, and the like are considered to be other uses of the single-walled nanotube. In addition, the use of the single-walled nanotube is considered to be expanded further by surface functionalization thereof, a metal coating, and the inclusion of foreign substances.

Hitherto, the inventors have proposed several manufacturing methods using a fluidized bed as a method of manufacturing large quantities of single-layer carbon nanotubes (for example, see PTL 1). According to the method disclosed in PTL 1, it is possible to generate large quantities of carbon nanotubes by using a granulated catalyst in which an active catalyst metal is carried on a carrier and by using a fluidized bed.

In addition, the manufacture of a conductive film by mixing the carbon nanotube obtained by the above-described method with a resin and depositing the mixture on a substrate has been performed (for example, see PTL 2). According to the method disclosed in PTL 2, first, a carbon nanotube is generated by supplying a raw material source constituted by a catalyst, a reaction accelerator, a carbon source, and the like to a reaction region, which is a method referred to as a flow gas-phase chemical vapor deposition (CVD) method.

In addition, a method of manufacturing a carbon nanotube has been proposed by introducing a functional group into one end or both ends of a fibrous object having a hexagonal net surface columnar portion and by reacting the functional group in the fibrous object with a functional group in another fibrous object to connect a plurality of fibrous objects to each other (for example, see PTL 3).

### CITATION LIST

### Patent Literature

[PTL 1] Japanese Unexamined Patent Application, First Publication No. 2007-230816

[PTL 2] PCT International Publication No. WO2009/008291

[PTL 3] Japanese Unexamined Patent Application, First Publication No. 2008-280222

### Non-Patent Literature

[NPL 1] S, Iijima, Nature, 354, 56 (1991)

### SUMMARY OF INVENTION

### Problem to be Solved by the Invention

However, when a carbon nanotube is manufactured by the methods of the related art which are disclosed in PTLs 2 and 3, there is a problem in that high conductivity is not likely to be obtained. It is considered that this is because, in a catalyst for carbon nanotube production, a carbon nanotube generated from a metal catalyst carried in a carrier has an insufficient length. For this reason, the appearance of a catalyst capable of mass-producing a carbon nanotube having excellent conductivity has been desired.

The present invention is contrived in view of such situations, and an object thereof is to provide a catalyst for carbon nanotube production capable of continuously mass-producing a carbon nanotube having a long fiber length and excellent conductivity.

### Solution to Problem

In order to solve the above-described problems, the inventors have performed earnest examination on a catalyst used to manufacture a carbon nanotube. As a result, first, the inventors have found that a fiber length of a carbon nanotube to be generated is required to be set to equal to or larger than 0.1 μm in order to obtain high conductivity. In this manner, the inventors have considered that, in order to generate a carbon nanotube having a fiber length of equal to or larger than 0.1 μm, first, a space (growth space) for generating the carbon nanotube, that is, a pore of a granulated catalyst is required to have a size larger than a predetermined size. In addition, the inventors have found that, in order to obtain a pore having a large size, (1) a method of increasing a pore volume after manufacturing a granulated catalyst by making a particle diameter uniform, (2) a method of flattening a carrier particle, (3) a method of mixing a carrier particle with a pore material, shaping the mixture, and then removing the pore material, and the like are effective, and have completed the present invention.

That is, the catalyst for carbon nanotube production according to the present invention includes a carrier particle which is configured to include a metal oxide and has voids therein, and a metal catalyst which is carried on the carrier particle. When an integrated value of volumes of pores having a pore size of equal to or larger than 0.1 μm is set to be a volume of the voids per unit mass of the carrier particle in a pore distribution curve of the carrier particle which is obtained by a mercury penetration method, a volume of the voids is in a range of 0.6 cm³/g to 2.2 cm³/g.

According to the catalyst for carbon nanotube production having such a configuration, the volume of the pores of the carrier particle, that is, the volume of the voids is set to be in the above-described range, and thus it is possible to secure a sufficient space capable of growing the carbon nanotubes. Accordingly, a fiber length of the carbon nanotube generated from a metal catalyst carried on the surface of the carrier particle is increased, and thus the conductivity of the carbon nanotube is improved.

In the catalyst for carbon nanotube production having the above-described configuration, when a configuration is adopted in which the carrier particle is constituted by flat metal oxide particles clumping together, a sufficient growth space of the carbon nanotube can be further secured. Accordingly, the carbon nanotube having a long fiber length is more reliably obtained, and thus conductivity is improved.

In addition, a method of manufacturing a catalyst for carbon nanotube production according to the present invention includes a process of obtaining a carrier particle, which is configured to include a metal oxide and has voids therein, by adding alcohol, in dispersing metal oxide particles (catalyst carrier) in the alcohol, to the extent that the metal oxide particles may be sufficiently impregnated with the alcohol (high-grade alcohol being sold on the market: 99.9% or more) to adjust a metal oxide solution, by performing drying thereon, and then by further performing firing thereon, a process of dispersing a metal catalyst in the alcohol to adjust a nano-metal solution before dying and firing the carrier particle, and a process of coating the surface of the carrier particle with the nano-metal solution, performing drying thereon, and then further performing firing thereon. The process of obtaining the carrier particle includes drying and firing the metal oxide solution while controlling a volume of the voids to be in a range of 0.6 cm³/g to 2.2 cm³/g when an integrated value of volumes of pores having a pore size of equal to or larger than 0.1 μm is set to be a volume of the voids per unit mass of the carrier particle in a pore distribution curve of the carrier particle which is obtained by a mercury penetration method.

According to the method of manufacturing a catalyst for carbon nanotube production having such a configuration, the amount of alcohol to be added in a metal oxide solution and a process of drying and firing the metal oxide solution are properly adjusted, and thus it is possible to control the volume of pores of a carrier particle, that is, the volume of voids to be in the above-described range. Accordingly, it is possible to secure a sufficient space capable of growing a carbon nanotube, and thus a fiber length of the carbon nanotube generated from a metal catalyst carried on the surface of the carrier particle is increased. Therefore, it is possible to manufacture the carbon nanotube having excellent conductivity.

### Advantageous Effects of Invention

According to a catalyst for carbon nanotube production of the present invention, in a pore distribution curve of a carrier particle which is obtained by a mercury penetration method, an integrated value of volumes of pores having a pore size of equal to or larger than 0.1 μm is set to be the volume of pores per unit mass of the carrier particle, and the volume of voids is set to be in the above-described range, and thus it is possible to sufficiently secure a space capable of growing a carbon nanotube. Accordingly, a fiber length of the carbon nanotube generated from a metal catalyst carried on the surface of the carrier particle is increased, and thus the conductivity of the carbon nanotube A is improved. Therefore, it is possible to obtain a carbon nanotube having excellent conductivity with high productivity.

In addition, according to a method of manufacturing a catalyst for carbon nanotube production of the present invention, the amount of alcohol to be added in a metal oxide solution and a process of drying and firing the metal oxide solution are properly adjusted, and thus it is possible to control the volume of pores of a carrier particle, that is, the volume of voids to be in the above-described range. Accordingly, it is possible to secure a sufficient space capable of growing a carbon nanotube, and thus a fiber length of the carbon nanotube generated from a metal catalyst carried on the surface of the carrier particle is increased. Therefore, it is possible to efficiently mass-produce a carbon nanotube having excellent conductivity.

### BRIEF DESCRIPTION OF DRAWINGS

FIG. 1 is a diagram showing a catalyst for carbon nanotube production which is constituted by a carrier particle and a metal catalyst, and is a schematic diagram showing a state where a carbon nanotube is generated from the metal catalyst.

FIG. 2 is a schematic diagram showing a method of manufacturing the catalyst for carbon nanotube production shown in FIG. 1.

FIG. 3 is an electron micrograph showing the fiber length of a carbon nanotube generated from a metal catalyst.

FIG. 4 is a graph showing a pore distribution curve constituted by a relationship between a pore size of a carrier particle and a differential pore volume.

FIG. 5 is a graph showing a relationship between a pore size of a carrier particle and a pore volume.

FIG. 6 is a schematic diagram showing a process of generating a carbon nanotube by filling a catalyst for carbon nanotube production into a fluidized bed and by supplying a source gas thereto.

FIG. 7 is a diagram showing voids of a carrier particle and is a schematic diagram showing a state where voids are present between primary particles in a secondary particle constituted by the primary particles clumping together.

FIG. 8 is a graph showing particle size distribution of a carrier particle.

FIG. 9 is an electron micrograph showing an example of a carrier particle constituted by flat metal oxide particles clumping together.

FIG. 10 is a graph showing a relationship between a degree of circularity of a particle contour of a carrier particle and a void fraction.

FIG. 11 is a graph showing a relationship between an integrated value of volumes of pores having a pore size of equal to or larger than 0.1 μm and a surface resistivity of a carbon nanotube.

### DESCRIPTION OF EMBODIMENTS

Hereinafter, details of a catalyst for carbon nanotube production according to the present invention will be described with reference to the accompanying drawings.

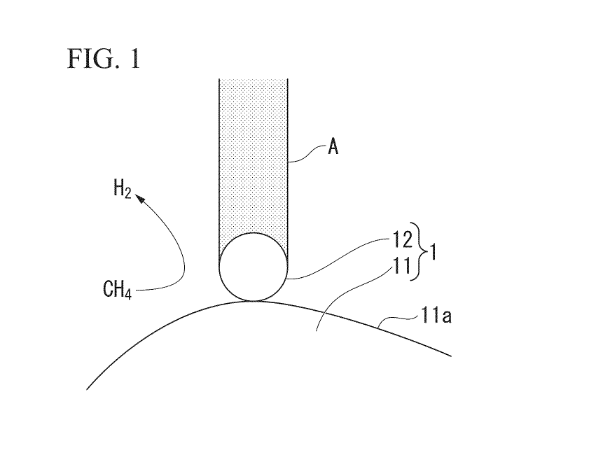

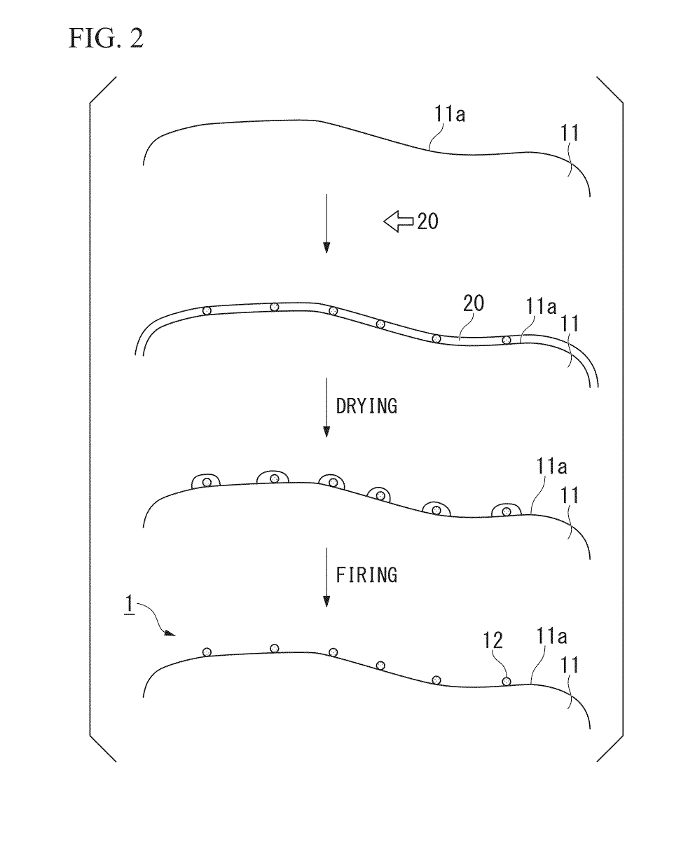

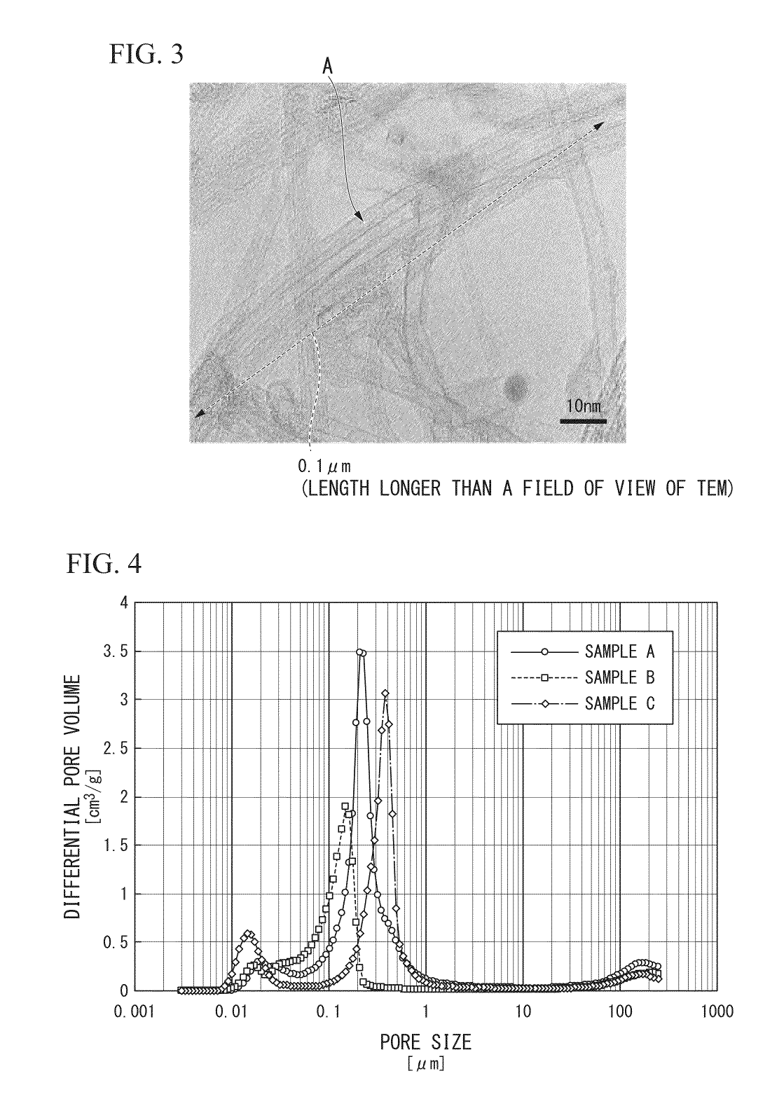

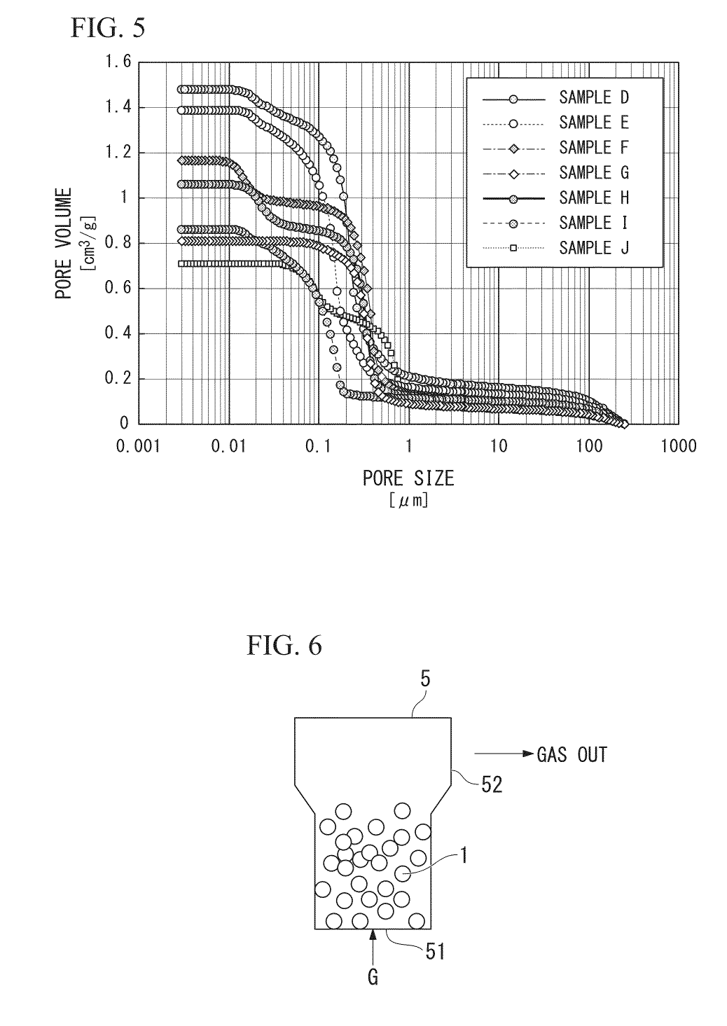

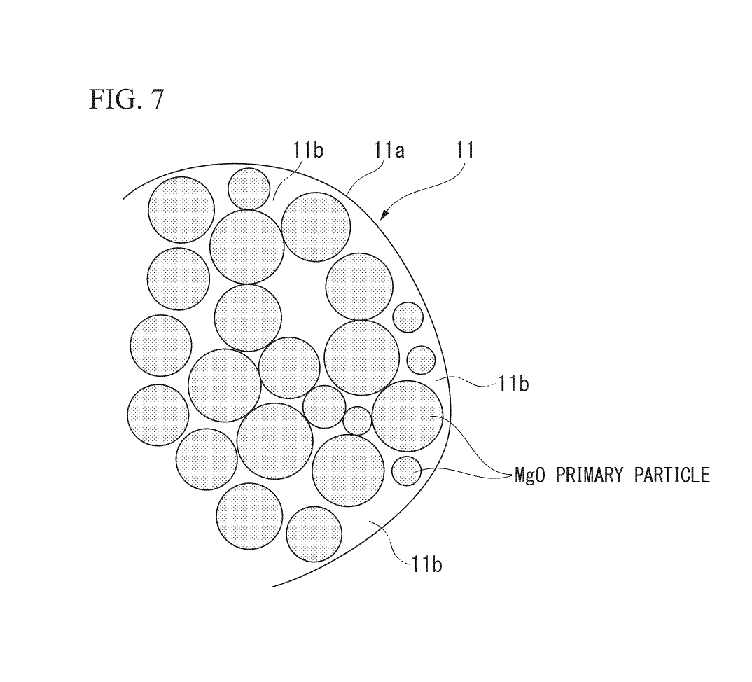

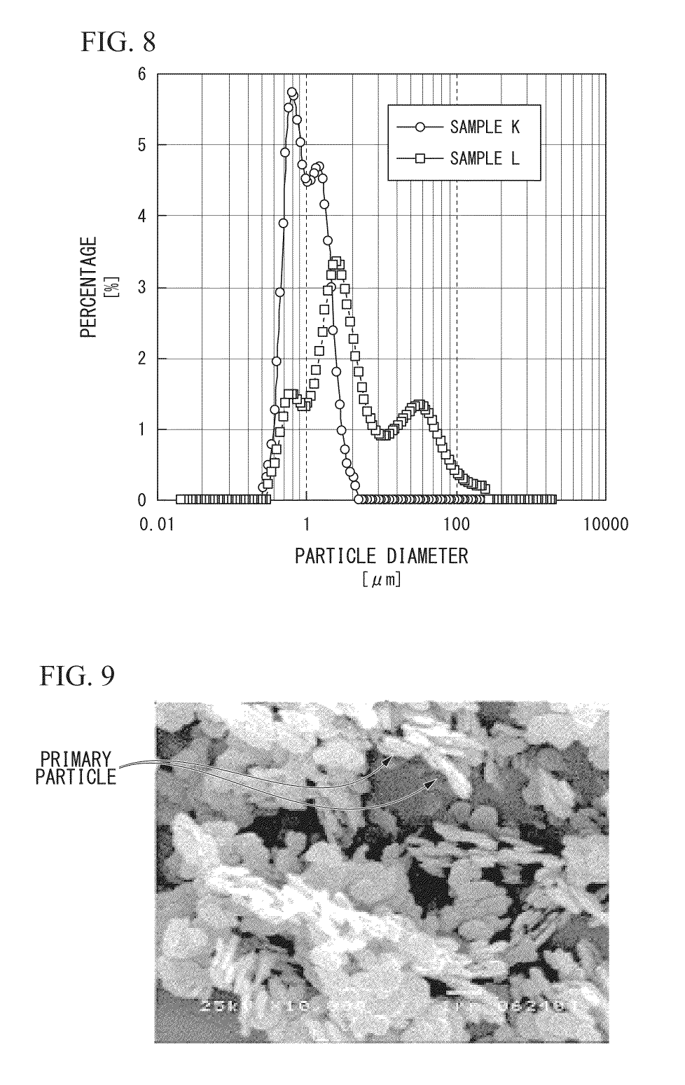

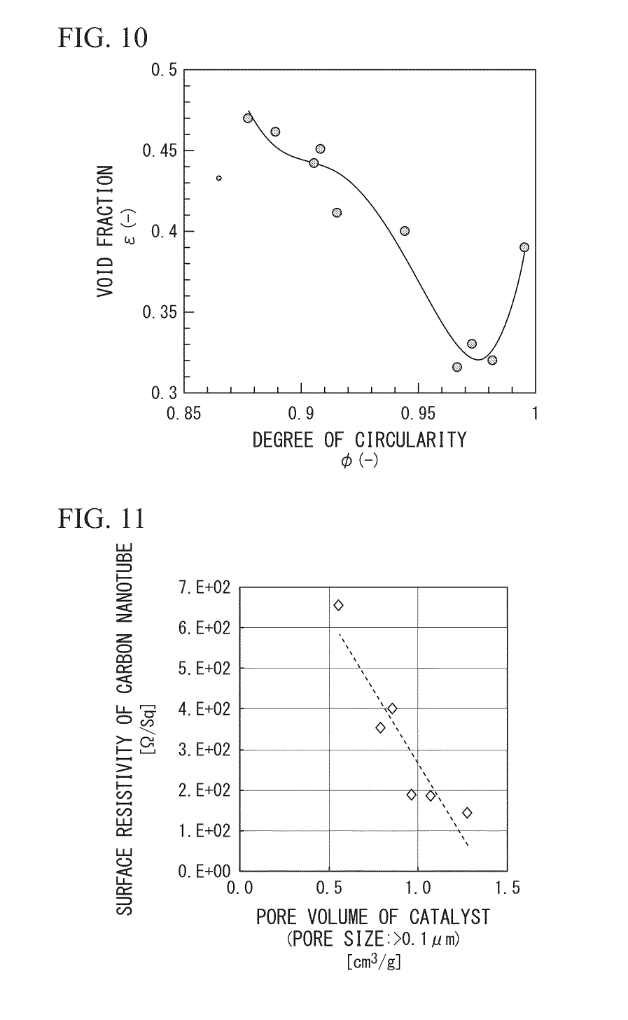

FIGS. 1 to 11 are diagrams showing an embodiment of a catalyst for carbon nanotube production according to the present invention. FIG. 1 is a diagram showing a catalyst for carbon nanotube production which is constituted by a carrier including MgO and a metal catalyst carried on the carrier. FIG. 2 is a diagram showing an example of a method of manufacturing the catalyst for carbon nanotube production shown in FIG. 1. FIG. 3 is an electron micrograph showing a fiber length of a carbon nanotube generated from a metal catalyst. FIG. 4 is a graph showing a pore distribution curve which is constituted by a relationship between a pore size of a carrier particle and a differential pore volume. FIG. 5 is a graph showing a relationship between a pore size of a carrier particle and a pore volume. FIG. 6 is a diagram showing a process of generating the carbon nanotube shown in FIG. 1 by filling a catalyst for carbon nanotube production into a fluidized bed and by supplying a source gas thereto. FIG. 7 is a diagram showing a state where voids are present between primary particles in a secondary particle constituted by the primary particles of a carrier particle which clump together. FIG. 8 is a graph showing particle size distribution of a carrier particle. FIG. 9 is an electron micrograph showing an example of a carrier particle constituted by flat metal oxide particles clumping together. FIG. 10 is a graph showing a relationship between a degree of circularity of a particle contour of a carrier particle and a void fraction. FIG. 11 is a graph showing a relationship between an integrated value of volumes of pores having a pore size of equal to or larger than 0.1 μm and a surface resistivity of a carbon nanotube.

As described above, the inventors have repeated earnest examination in order to obtain a carbon nanotube having excellent conductivity in manufacturing the carbon nanotube using a fluidized bed. As a result, the inventors have found that the fiber length of a carbon nanotube to be generated is required to be set to be equal to or larger than 0.1 μm in order to increase the conductivity of the carbon nanotube. The inventors considered that a space for generating a carbon nanotube, that is, a pore of a granulated catalyst, is required to be larger than a predetermined size in order to generate a carbon nanotube having a fiber length of equal to or larger than 0.1 μm and repeated the examination, and thus completed the present invention.

That is, as shown in FIG. 1, a catalyst for carbon nanotube production (hereinafter, may be simply referred to as a catalyst) 1 of this embodiment includes a carrier particle 11 which is configured to include a metal oxide and has voids 11b (see FIG. 7) therein, and a metal catalyst 12 which is carried on the carrier particle 11. The catalyst is schematically configured such that, in a pore distribution curve of the carrier particle 11 which is obtained by a mercury penetration method, a volume V of the voids 11b is set to be in a range of 0.6 cm³/g to 2.2 cm³/g when an integrated value of volumes of pores having a pore size of equal to or larger than 0.1 μm is set to be a volume of the voids 11b per unit mass of the carrier particle 11.

Hereinafter, components of the catalyst 1 of this embodiment will be described in detail.

The carrier particle 11 constituting the catalyst 1 of this embodiment includes a metal oxide. Examples of the metal oxide include an aluminum compound such as alumina, silica, sodium aluminate, alum, and aluminum phosphate, a calcium compound such as calcium oxide, calcium carbonate, and calcium sulfate, and an apatite compound such as calcium phosphate and magnesium phosphate, further include a magnesium compound such as magnesium hydroxide, magnesium oxide, and magnesium sulfate, and any of these can be appropriately adopted as the metal oxide. In addition, when the conductivity, generation efficiency, and the like of a generated carbon nanotube are considered, highly-pure magnesium oxide (MgO) to be described in this embodiment is preferably used.

Here, appetite is a mineral which has a composition of M²⁺₁₀(Z⁵⁻O₄)₆X⁻₂ and in which one or two or more of the following elements are contained in a solid solution state with respect to M, ZO₄, and X.

M: Ca, Pb, Ba, Sr, Cd, Zn, Ni, Mg, Na, K, Fe, Al, and the like

ZO₄: PO₄, AsO₄, VO₄, SO₄, SiO₄, CO₃

X: F, OH, Cl, Br, O, I

In the present invention, the carrier particle 11 constituting the catalyst 1 has the voids 11b therein as shown in the schematic diagram of FIG. 7. The void 11b is a void formed between primary particles in a secondary particle constituted by the primary particles of a metal oxide such as MgO clumping together. In the pore distribution curve of the carrier particle 11 which is obtained by a mercury penetration method of the present invention, when an integrated value of volumes of pores having a pore size of equal to or larger than 0.1 μm is set to be the volume V of the voids 11b per unit mass of the carrier particle 11, the volume of the voids 11b is set to be in a range of 0.6 cm³/g to 2.2 cm³/g.

The inventors have repeated earnest examination and have examined properties of a carbon nanotube exhibiting satisfactory conductivity. Then, the inventors have found that, in order to obtain sufficient conductivity, it is necessary to set a fiber length of the carbon nanotube to be equal to or larger than 0.1 μm as shown in the transmission electron microscope (TEM) image of FIG. 3. Based on this result, the inventors have considered that, in order to obtain a carbon nanotube having a fiber length of equal to or larger than 0.1 μm, it is necessary to set a growth space for generating a carbon nanotube, that is, the void 11b of the carrier particle 11 to have a size of equal to or larger than 0.1 μm. As a result of generating the carbon nanotube using a granulated catalyst having a pore of equal to or larger than 0.1 μm, it becomes obvious that the conductivity of the carbon nanotube is improved.

The graph of FIG. 11 shows a relationship between an integrated value of pore volumes (pores having a diameter of equal to or larger than 0.1 μm) and a surface resistivity of a carbon nanotube. As shown in FIG. 11, it can be understood that as an integrated value of volumes of pores having a pore size of equal to or larger than 0.1 μm increases, a surface resistivity of a carbon nanotube generated from a catalyst decreases and conductivity is improved and that, with the pore volume being in a range of 0.5 cm³/g to 1.3 cm³/g, the surface resistivity decreases in proportion to the volume.

A method of measuring a surface resistivity (electrical conductivity) of the carbon nanotube A includes a method of mixing a carbon nanotube obtained in the above-described procedure with polyaniline in a predetermined amount on the basis of a method specified in JIS K 7194, forming a thin film having a thickness of 2 μm by using the mixture, and then measuring the surface resistance of the thin film.

Here, as shown in the pore distribution graph of FIG. 4, when a pore size of a carrier particle is equal to or larger than 0.1 μm, a differential pore volume per unit mass is remarkably increased, and thus it can be understood that large voids of the carrier particle, that is, a large growth space capable of generating a carbon nanotube can be secured. On the other hand, it can be understood that when the pore size of the carrier particle being less than 0.1 μm, the voids of the carrier particle is difficult to be sufficiently secured. Meanwhile, in the graph of FIG. 5, it can be understood that the pore size being larger than 1 μm does not contribute to the pore volume.

In addition, as a result of the inventors' repeated studies, the inventors have found that, in order to obtain a large pore for generating the carbon nanotube A having a fiber length of equal to or larger than 0.1 μm.

(1) a method of increasing a pore volume after manufacturing a granulated catalyst by making a particle diameter uniform,

(2) a method of flattening a carrier particle, and

(3) a method of mixing a carrier particle with an organic template (pore material), shaping the mixture, and then removing the organic template, and the like are effective.

First, as described above in (1) and also shown in the particle size distribution graph of FIG. 8, a method is used of increasing a pore volume of the carrier particle 11 after granulation by making a particle diameter uniform in a range of an average particle diameter being equal to or larger than 0.1 μm. Here, in general, as the distribution of an average particle diameter of a primary particle of a carrier particle is widened, there are problems of the primary particle of the carrier particle being densely filled in a secondary particle and of a pore volume, which is a growth space of a carbon nanotube, not being able to be sufficiently secured. As shown in the graph of FIG. 8, the particle size distribution is set to be in a certain range by making the average particle diameter uniform, and thus it is possible to sufficiently secure the pore volume of the carrier particle 11. Here, in the graph of FIG. 8, a sample K is an example according to the present invention, and a sample L is an example of the related art.

In addition, as described above in (2), a method is used of increasing the pore volume of the carrier particle 11 after granulation by adopting a configuration in which the carrier particle 11 is constituted by flat metal oxide particles clumping together as shown in the TEM image of FIG. 9. The graph of FIG. 10 shows a relationship between the degree of circularity, which is a particle contour of the carrier particle 11, and a void fraction indicating the size of the void 11b which is secured in the carrier particle 11. As shown in FIG. 10, it can be understood that as the metal oxide particle constituting the carrier particle is flattened, the void fraction improves and the pore volume increases.

In the present invention, as described above, the carrier particle 11 is configured to be constituted by the flat metal oxide particles clumping together, and thus it is possible to increase the pore volume and to sufficiently secure a growth space of the carbon nanotube.

In addition, as described above in (3), there is a consideration of a method of mixing a carrier particle with an organic template (pore material), shaping the mixture, and then removing the organic template, that is, a method of mixing a carrier particle with a resin, shaping the mixture, and then removing the resin to thereby increase the pore volume of the carrier particle after granulation.

Meanwhile, in the present invention, a pore distribution curve serving as an index indicating the volume of the voids 11b of the carrier particle 11 is obtained by measurement using a mercury penetration method which is known in the related art. Here, for example, when the volume of the voids of the carrier particle is shown by a specific surface area method, the pore distribution curve is not preferable as an index indicating the pore volume due to the influence of a pore having a size of equal to or less than 0.1 μm. That is, in the present invention, a presence ratio of the voids 11b, that is, the pores in the carrier particle 11 are accurately evaluated by using a mercury penetration method.

According to the catalyst 1 of the present invention, the volume of the pores of the carrier particle 11, that is, the volume of the voids 11b is set to be in the above-described range, and thus it is possible to secure a sufficient space capable of growing the carbon nanotube A. Accordingly, a fiber length of the carbon nanotube A generated from the metal catalyst 12 which is carried on a surface 11a of the carrier particle 11 is increased, and conductivity is improved. In addition, an effect of remarkably improving conductivity in a case where the carbon nanotube A obtained by the catalyst 1 and a resin are mixed with each other and the mixture is shaped and used.

As the metal catalyst 12 which constitutes the catalyst 1 of this embodiment and which is carried on the surface 11a of the carrier particle 11, for example, any one of V, Cr, Mn, Fe, Co, Ni, Cu, and Zn or a combination thereof can be adopted. In particular, Fe in the above-described materials is preferably adopted as the metal catalyst 12 from the viewpoint of improving the conductivity, yield, and the like of the carbon nanotube A.

Next, an example of a method of manufacturing the above-described catalyst 1 for carbon nanotube production will be described with reference to FIG. 2.

The method of manufacturing the catalyst 1 for carbon nanotube production according to the present invention includes a process of obtaining the carrier particle 11, which is configured to include a metal oxide and has the voids 11b therein, by adding alcohol, in dispersing metal oxide particles in the alcohol, to the extent that the metal oxide particles can be sufficiently impregnated with the alcohol (high-grade alcohol being sold on the market: 99.9% or more) to adjust a metal oxide solution, by drying the metal oxide solution in which an Fe catalyst is added, and by further firing the metal oxide solution, a process of dispersing the metal catalyst 12 in the alcohol to adjust a nano-metal solution 20, and a process of coating the surface 11a of the carrier particle 11 with the nano-metal solution 20, performing drying thereon, and then further performing firing thereon. The above-described process of obtaining the carrier particle 11 is a method of drying and firing the metal oxide solution while controlling the volume of the voids 11b to be in a range of 0.6 cm³/g to 2.2 cm³/g when an integrated value of volumes of pores having a pore size of equal to or larger than 0.1 μm is set to be the volume of the voids 11b per unit mass of the carrier particle 11 in the pore distribution curve of the carrier particle 11 which is obtained by a mercury penetration method.

First, in dispersing the metal oxide particles, not shown in the drawing, in the alcohol, the metal oxide solution is adjusted by adding the alcohol to the extent that the metal oxide particles are sufficiently impregnated with high-grade alcohol being sold on the market (99.9% or more). Thereafter, the metal oxide solution is dried and then is further fired, thereby manufacturing the carrier particle 11 which is configured to include a metal oxide and has the voids 11b therein.

In this embodiment, regarding the above-described process of obtaining the carrier particle, a volume ratio between the metal oxide to the alcohol is set to approximately 1:1. The adjusted metal oxide solution is evaporated and dried while being rotated by an evaporator. Further, in this embodiment, the carrier particle 11 is manufactured under firing conditions after drying in which a heating temperature is set to 800° C. and a heating time is set to one hour, and under the condition of an atmosphere including 1% of hydrogen (an inert gas such as nitrogen, Ar, or He is included as a balancing gas). Thus, it is possible to sufficiently secure the voids 11b in the carrier particle 11, and to control the volume V of the voids 11b to be in a range of 0.6 cm³/g to 2.2 cm³/g when an integrated value of volumes of pores having a pore size of equal to or larger than 0.1 μm is set to be a volume of the voids 11b per unit mass of the carrier particle 11 in the pore distribution curve obtained by a mercury penetration method.

Subsequently, in the process of adjusting the nano-metal solution 20, the metal catalyst 12 is dispersed in alcohol using a mixing tank and the like not shown in the drawing.

Subsequently, the surface 11a of the carrier particle 11 is coated with the nano-metal solution 20, and then drying is performed thereon. Then, firing is performed thereon, and thus it is possible to carry a nano-metal, which is the metal catalyst (Fe) 12, on the surface 11a of the carrier particle 11. At this time, the above-described materials can be adopted as the carrier particle 11 and the metal catalyst 12.

When the catalyst 1 is manufactured by the above-described method, in particular, the mixing ratio of alcohol with respect to the metal oxide solution is set to be in the above-described range, and the process of drying and firing the metal oxide solution is properly adjusted under the above-described conditions, it is thus possible to control the volume of the pores of the carrier particle 11, that is, the volume V of the voids 11b to be in the above-described range. Accordingly, since a space capable of growing the carbon nanotube A can be sufficiently secured, a fiber length of the carbon nanotube A generated from the metal catalyst 12 which is carried on the surface 11a of the carrier particle 11 is increased, and thus it is possible to manufacture the carbon nanotube A having excellent conductivity.

Next, an example of a method of generating and manufacturing the carbon nanotube A using the above-described catalyst 1 for carbon nanotube production will be described with reference to FIG. 6.

When the carbon nanotube A is manufactured, a fluidized bed 5 shown in FIG. 6 can be used. The fluidized bed 5 is filled with the catalyst 1, and is configured such that a source gas (carbon source) G is supplied from a source gas supply port 51 formed in the lower portion thereof. In the source gas G, unreacted gas and surplus gas are configured to be discharged from the exhaust port 52.

When the carbon nanotube A is manufactured using the fluidized bed 5, first, the source gas G is supplied from the source gas supply port 51 and reacts with the catalyst while injecting the catalyst 1 for carbon nanotube production as a fluidized material into the fluidized bed 5 and causing the catalyst to flow. Accordingly, as shown in FIG. 1, a nano-order tube-shaped carbon material is sequentially grown from the metal catalyst 12 which is carried on the surface 11a of the carrier particle 11 and which is miniaturized. Thus, it is possible to generate the carbon nanotube A from the catalyst 1.

Meanwhile, in manufacturing the carbon nanotube A by a fluidized bed system using the catalyst 1 of this embodiment, an average particle diameter of the catalyst 1 is preferably in a range of 0.1 mm to 10 mm, and is more preferably in a range of 0.5 mm to 2 mm from the viewpoint of improving yield.

In addition, the source gas G which is a carbon source is not particularly limited as long as the source gas is a compound containing carbon. Examples of the source gas can include alkanes such as methane, ethane, propane, and hexane, an unsaturated organic compound such as ethylene, propylene, and acetylene, an aromatic compound such as benzene and toluene, organic compounds such as alcohols, ethers, and carboxylic acids which have an oxygen-containing functional group, a polymeric material such as polyethylene and polypropylene, oil, coal (a coal conversion gas is included), and the like, in addition to CO and CO₂. In addition, from the viewpoint of controlling the oxygen concentration, it is also possible to supply a combination of two or more of CO, CO₂, H₂O, alcohols, ethers, carboxylic acids, and the like, which are oxygenated carbon sources, and a carbon source not containing oxygen.

In addition, when the carbon nanotube A is manufactured, the temperature within the fluidized bed 5 is preferably set to be in a range of 300° C. to 1300° C., and is more preferably set to be in a range of 400° C. to 1200° C. In this manner, the inside of the fluidized bed 5 is made to have an appropriate constant temperature, and the source gas G, which is a carbon raw material such as methane, is caused to come into contact with the catalyst 1 for a given length of time under an environment of coexisting of an impurity carbon decomposition product, and thus the carbon nanotube A is generated from the metal catalyst 12 which is carried on the carrier particle 11 as shown in FIG. 1.

According to the above-described catalyst 1 for carbon nanotube production of the present invention, in the pore distribution curve of the carrier particle 11 which is obtained by a mercury penetration method, an integrated value of volumes of pores having a pore size of equal to or larger than 0.1 μm is set to be the volume of the voids 11b per unit mass of the carrier particle 11, and the volume V of the voids 11b is set to be in the above-described range, and thus it is possible to secure a sufficient space capable of growing a carbon nanotube. Accordingly, a fiber length of the carbon nanotube A generated from the metal catalyst 12 carried on the surface 11a of the carrier particle 11 is increased, and thus the conductivity of the carbon nanotube A is improved. Therefore, it is possible to obtain the carbon nanotube A having excellent conductivity with high productivity.

In addition, according to a method of manufacturing the catalyst 1 for carbon nanotube production of the present invention, the amount of alcohol to be added in a metal oxide solution and a process of drying and firing the metal oxide solution are properly adjusted, and thus it is possible to control the volume of the pores of the carrier particle 11, that is, the volume V of the voids 11b to be in the above-described range. Accordingly, it is possible to secure a sufficient space capable of growing the carbon nanotube A, and thus a fiber length of the carbon nanotube A generated from the metal catalyst 12 carried on the surface 11a of the carrier particle 11 is increased. Therefore, it is possible to efficiently mass-produce the carbon nanotube A having excellent conductivity.

### EXAMPLES

Hereinafter, a catalyst for carbon nanotube production will be described in more detail with reference to an example, but the present invention is not limited to this example.

[Manufacture of Sample Material (Sample of Catalyst)]

In this example, first, a catalyst particle constituted by MgO particles was manufactured as a catalyst particle. At this time, first, the MgO particles as metal oxide particles were dispersed in alcohol in which Fe was dissolved. Thereafter, firing was performed thereon, thereby creating a catalyst for carbon nanotube production according to the example of the present invention and a comparative example, which was formed by carrying nano-metal (metal catalyst: Fe) on the surface of the MgO carrier particle.

[Evaluation Test Items]

Various evaluation tests of items described below were performed on the sample material created in the above-described procedure.

“Volume of Voids of Carrier Particle”

When the catalyst for carbon nanotube production was created in the above-described procedure, in a step of creating a carrier particle constituted by MgO, a volume V of voids of the carrier particle was examined. At this time, the volume of the voids was measured using a mercury penetration method.

First, regarding the carrier particle obtained in the above-described procedure, a pore volume was examined using a mercury penetration method which is well known in the related art, and the pore distribution curve as shown in the graph of FIG. 4 was obtained on the basis of this data. An integrated value of volumes of pores having a pore size of equal to or larger than 0.1 μm was obtained from the pore distribution curve, and this numerical value was set to be the volume of voids per unit mass of the carrier particle.

“Conductivity of Carbon Nanotube”

A carbon nanotube was created using the fluidized bed 5 shown in FIG. 6 as a manufacturing apparatus by using the sample material of the catalyst created in the above-described procedure, and the electrical conductivity of the carbon nanotube was examined.

First, methane gas was supplied as the source gas G from the source gas supply port 51 while injecting the catalyst, which is the sample material, as a fluidized material into the fluidized bed 5. At this time, the temperature within the fluidized bed 5 was made constant at 860° C., and a flow time of the methane gas was set to 10 minutes to 60 minutes (one hour). Based on such conditions and procedure, the methane gas was caused to come into contact with the catalyst which is the sample material, and thus the carbon nanotube A was generated from the metal catalyst carried on the carrier as shown in FIG. 1, and manufacturing was continuously performed.

Then, the conductivity of the carbon nanotube obtained in the above-described procedure was examined. At this time, the conductivity was evaluated by measuring a surface resistivity (Ω/sq) of the generated carbon nanotube. Regarding the surface resistivity of the carbon nanotube, 0.2 g of the carbon nanotubes, which were obtained in the above-described procedure, and 25 g of polyaniline were mixed with each other based on a method specified in JIS K 7194, a thin film having a thickness of 2 μm was formed using the mixture, and then the surface resistance of the thin film was measured.

[Evaluation Results]

According to the results of the above-described evaluation tests, the volume of the voids of the carrier particle created according to the conditions and procedure specified in the present invention was 0.6 cm³/g to 2.2 cm³/gm, which was within a specified range of the present invention.

In addition, when the carbon nanotube is manufactured by a fluidized bed system using the carrier particle having this void volume and a catalyst for carbon nanotube production, it is clarified that the carbon nanotube having a low surface resistivity and excellent conductivity is obtained.

Form the results of the above-described evaluation tests, it is clarified that the catalyst for carbon nanotube production according to the present invention can generate a carbon nanotube having excellent conductivity.

### INDUSTRIAL APPLICABILITY

According to the above-described catalyst for carbon nanotube production of the present invention, when an integrated value of volumes of pores having a pore size of equal to or larger than 0.1 μm is set to be the volume of voids per unit mass of the carrier particle in the pore distribution curve of the carrier particle which is obtained by a mercury penetration method, the volume of the voids is set to be in a range of 0.6 cm³/g to 2.2 cm³/g. Accordingly, since the conductivity of a carbon nanotube manufactured using the catalyst is remarkably improved, it is possible to realize mass-production of carbon nanotubes having high purity and excellent conductivity.

### REFERENCE SIGNS LIST

1 Catalyst for carbon nanotube production (catalyst)

11 Carrier particle

11a Surface (carrier)

11b Void (carrier)

12 Metal catalyst

20 NANO-METAL solution

A Carbon nanotube

1. A catalyst for carbon nanotube production, the catalyst comprising:
a carrier particle which is configured to include a metal oxide and has voids therein; and
a metal catalyst which is carried on the carrier particle,
wherein when an integrated value of volumes of pores having a pore size of equal to or larger than 0.1 μm is set to be a volume of the voids per unit mass of the carrier particle in a pore distribution curve of the carrier particle which is obtained by a mercury penetration method, a volume of the voids is in a range of 0.6 cm³/g to 2.2 cm³/g.

2. A method of manufacturing a catalyst for carbon nanotube production, the method comprising:
a process of obtaining a carrier particle, which is configured to include a metal oxide and has voids therein, by adding alcohol, in dispersing metal oxide particles in the alcohol, in an amount capable of impregnating the metal oxide particles with the alcohol to adjust a metal oxide solution, by drying the metal oxide solution, and then by further firing the metal oxide solution;
a process of dispersing a metal catalyst in the alcohol to adjust a nano-metal solution; and
a process of coating a surface of the carrier particle with the nano-metal solution, performing drying thereon, and then further performing firing thereon,
wherein the process of obtaining the carrier particle includes drying and firing the metal oxide solution while controlling a volume of the voids to be in a range of 0.6 cm³/g to 2.2 cm³/g when an integrated value of volumes of pores having a pore size of equal to or larger than 0.1 μm is set to be a volume of the voids per unit mass of the carrier particle in a pore distribution curve of the carrier particle which is obtained by a mercury penetration method.
